(19) United States
(12) Patent Application Publication
(10) Pub. No.: US 2006/0090332 A1
(43) Pub. Date: May 4, 2006

(54) Contactless conveyor system for the production of smart cards

(76) Inventor: Vahid Taban, Santa Ana, CA (US)

Correspondence Address: MORLAND C FISCHER, 2030 MAIN ST, SUITE 1050, IRVINE, CA, 92614, US

(21) Appl. No.: 11/261,371

(22) Filed: Oct. 28, 2005

Related U.S. Application Data
(63) Continuation of application No. 60/623,384, filed on Oct. 28, 2004.

(51) Int. Cl. H01R 43/00

(52) U.S. Cl. 29/748; 198/346.1

(57) ABSTRACT

A contactless conveyor system for the production of smart cards in which a series of smart card assembly workstations are located around a continuous, closed circuit track. Empty sheets are removed one at a time from a pull-out drawer at a sheet feeding station to be laid upon respective ones of a plurality of pallets. The pallets on which the empty sheets are laid are pushed around the track from one workstation to the next by motor-driven belts which move under the pallets. Finished sheets on which smart cards have been assembled are removed one at a time from the pallets to be stacked in a pull-out drawer at a sheet removal station. Each of the sheet feeding and sheet removal stations includes a frame on which an array of suction cups is mounted to generate a suction force for placing the empty sheets on and removing the finished sheets from successive ones of the pallets moving around the track.

### CROSS-REFERENCES TO RELATED APPLICATIONS

This application claims priority from Provisional Patent Application No. 60/623,384 filed Oct. 28, 2004.

### BACKGROUND OF THE INVENTION

1. Field of the Invention

This invention relates to a contactless conveyor system having a continuous closed circuit track around which plastic sheets are transported on pallets from one of a series of smart card assembly workstations to the next to facilitate the assembly of smart cards. The contactless conveyor system integrates the smart card assembly workstations and thereby reduces the common practice of operators having to manually handle and carry the sheets between separate and independent work cells during the manufacture of smart cards.

2. Background Art

Plastic cards have long been used for the purposes of making credit and debit transactions, operating magnetic locks, providing a means of personal identification, etc. Such cards typically include a permanent magnetic strip on which pre-determined information is encoded. However, such permanent magnetic strip is known to wear out over time so as to necessitate a replacement of the card on which the strip is carried. Consequently, the life and application of this type of card is undesirably limited.

What is more, the conventional magnetically encoded cards are static in nature. That is to say, the information stored on the permanent magnetic strips cannot be changed without issuing an altogether new card. In this same regard, the conventional magnetic strip cards must be placed within or in close proximity to a card reader to be effective. This increases the cost and complexity of a card system like that described above.

To overcome the aforementioned disadvantages of a permanent magnetic strip card, smart cards have been manufactured that carry one or more electronic chips by which large amounts of information can be transmitted, received and stored. Such smart cards typically have an antenna to enable their chips to communicate with external data transmitters/receivers without using a card reader. A radio frequency energy source is commonly used to excite the antenna to activate the chips to enable the reading, writing and storage of data.

A plurality of smart cards are usually manufactured on a single plastic sheet. Following assembly, the sheet is cut so that the plurality of smart cards are separated from one another. One common technique by which to manufacture the smart cards requires operators to carry successive sheets from one separate and independent work cell to another so that the smart card assembly steps can be performed. However, the need for individuals to transport the sheets between work cells increases handling which is known to decrease efficiency, increase damage and, consequently, adversely affect the reliability of the fully assembled smart cards.

### SUMMARY OF THE INVENTION

In general terms, a contactless conveyor system is disclosed which integrates a series of (e.g., robotic) smart card assembly workstations and avoids the heretofor common practice of operators having to carry sheets on which the smart cards are assembled from one independent and separate work cell to another. The conveyor system includes a continuous, closed circuit track having the series of smart card assembly workstations located therearound. A plurality of pallets are positioned on the track in spaced relation to one another. A corresponding plurality of flat, empty (i.e., pre-assembled) plastic sheets on which the smart cards are to be assembled are initially laid on and transported by respective ones of the pallets. The pallets are moved around the track from one workstation to the next by means of motor-driven belts which rotate under the pallets.

The conveyor system includes a single sheet feeding station having a pull-out drawer located below the track. A stack of the empty sheets are loaded into the pull-out drawer. The sheet feeding station also has a suction cup array frame which carries an array of suction cups at which a suction force is generated. A pneumatic cylinder is connected to the suction cup array frame for moving the frame and the array of suction cups carried thereby into contact with the stack of empty sheets in the pull-out drawer. The array of suction cups applies the suction force for lifting successive ones of the sheets out of the drawer and laying the sheets on respective pallets that ride along the track under the suction cup array frame.

The conveyor system also includes a single sheet removal station having a pull-out drawer located below the track. The sheet removal station has a suction cup array frame and a pneumatic cylinder that are identical to those found at the sheet feeding station. The array of suction cups associated with the suction cup array frame of the sheet removal station is moved into contact with and applies a suction force for lifting successive ones of the fully assembled sheets off the pallets that have traveled around the track between the smart card assembly workstations to complete the smart card assembly process. The fully assembled sheets are then stacked by the suction cup array frame within the pull-out drawer of the sheet removal station.

Each pallet for transporting a sheet around the track from one smart card assembly workstation to the next includes a hard (e.g., granite) and non-electrically conductive top to enable an antenna welding operation to be completed and tested. The top of the pallet has rows of vacuum holes extending therethrough. Connected to the top of the pallet is a vacuum manifold plate having rows of vacuum channels running therealong. The vacuum channels of the vacuum manifold plate communicate with the vacuum holes through the top to establish continuous vacuum passages through the pallet. One or a pair of vacuum generators create a vacuum, whereby a corresponding suction force is applied through the vacuum passages of the pallet for holding a sheet down against the top of the pallet as smart cards are assembled on the sheet.

A pallet lift and position platform is located at each of the series of smart card assembly workstations of the conveyor system for lifting successive ones of the pallets off the track to enable the robotic assembly of smart cards on the sheets being transported by the pallets. The lift and position platform has the aforementioned one or a pair of vacuum generators and a pair of suction cups for creating a vacuum and for applying the corresponding suction force through the vacuum passages of the pallet for holding the sheet against the top of the pallet during the assembly of smart cards thereon.

### BRIEF DESCRIPTION OF THE DRAWINGS

FIG. 1 is a perspective view of a contactless conveyor system for the manufacture of smart cards according to a preferred embodiment of the present invention;

FIG. 2 is a top view of the conveyor system shown in FIG. 1;

FIG. 3 shows a pull-out drawer at a sheet feeding station of the conveyor system of FIGS. 1 and 2 in which empty sheets are stacked and on which sheets smart cards are to be assembled;

FIG. 4 shows a partially broken away view of a pallet to transport an empty sheet from the pull-out drawer of FIG. 3 along the conveyor system so that smart cards can be assembled on the sheet;

FIG. 5 is an exploded view of the pallet shown in FIG. 4;

FIG. 6 shows a sheet feeding station of the conveyor system of FIGS. 1 and 2 for lifting up successive ones of the sheets that are stacked within the pull-out drawer of FIG. 3;

FIG. 7 shows the front of a sheet feeding station frame of the sheet feeding station of FIG. 6;

FIG. 8 shows the rear of the sheet feeding station frame of FIG. 7;

FIG. 9 shows a suction cup array frame of the sheet feeding station of FIG. 6; and

FIG. 10 shows a pallet lift and position platform located at each of a series of smart card assembly workstations around the conveyor system for lifting successive pallets during the assembly of smart cards on sheets that are transported by the pallets.

### DESCRIPTION OF THE PREFERRED EMBODIMENT

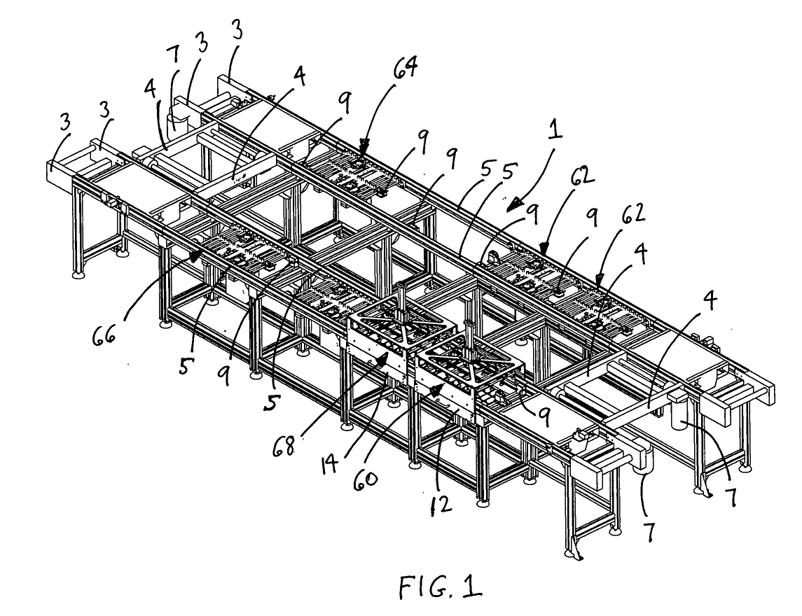

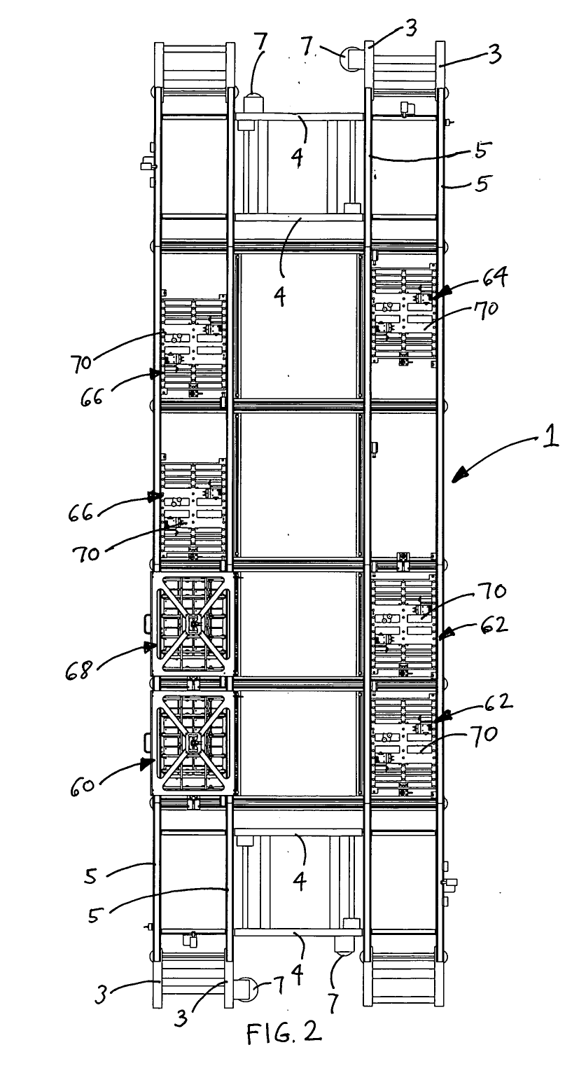

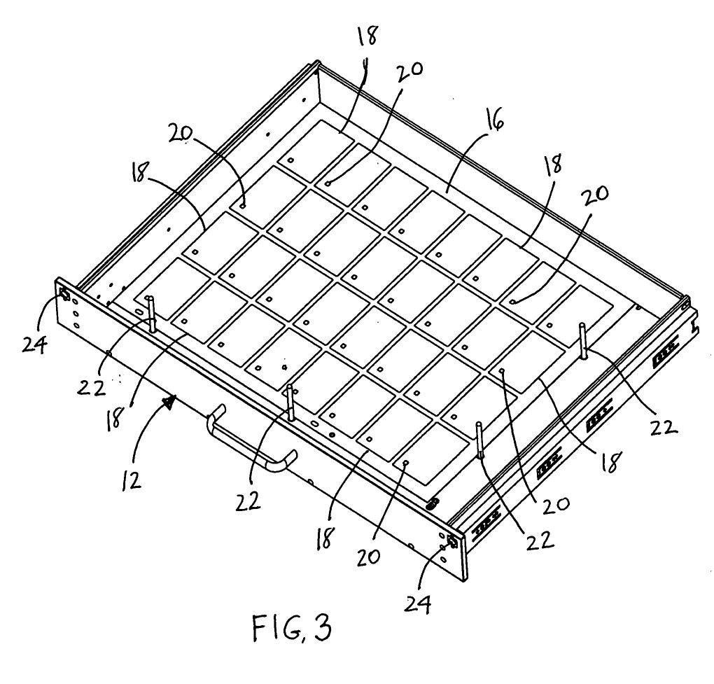

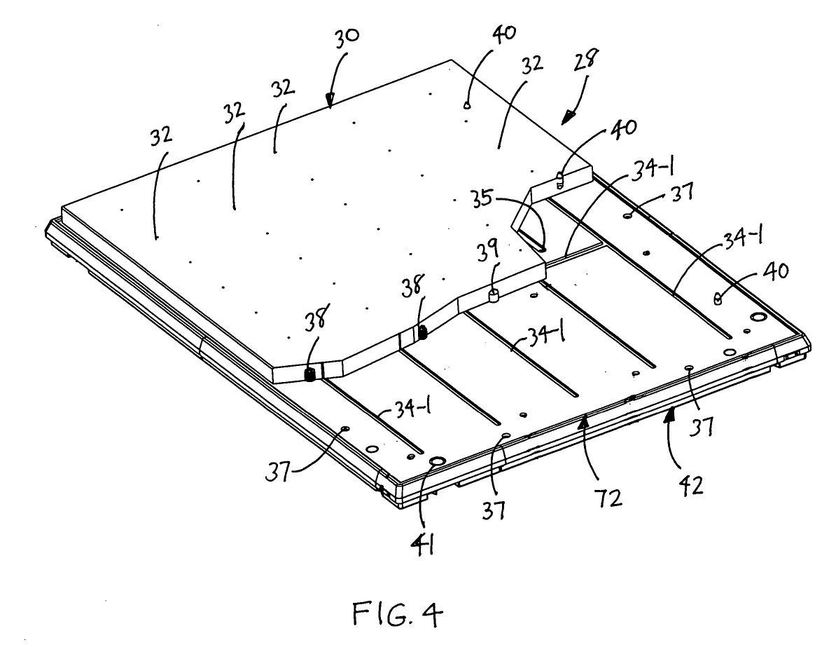

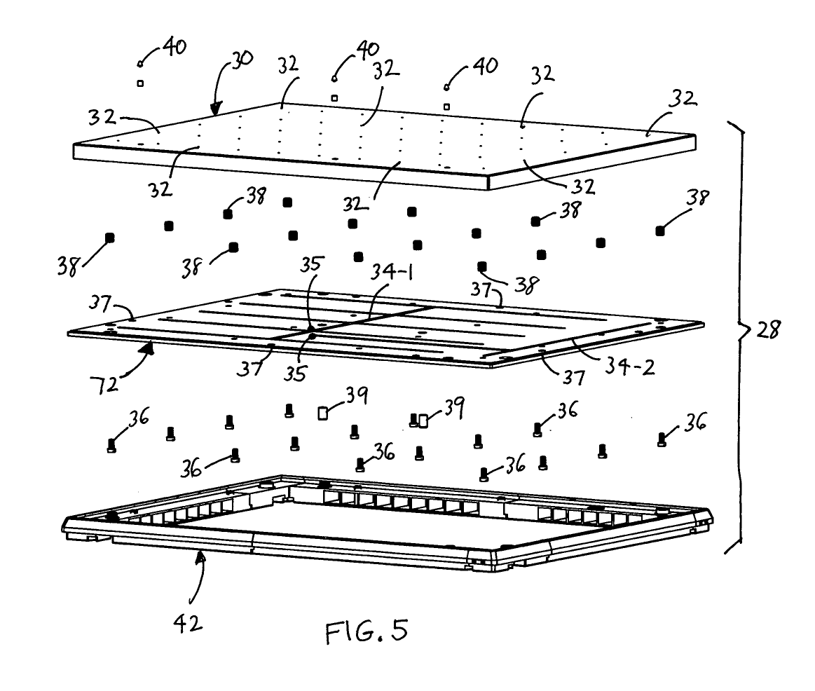

FIGS. 1 and 2 of the drawings illustrate a motor-driven contactless conveyor system 1 having a series of (e.g., robotically-controlled) workstations at which flat sheets (such as those designated 16 in FIG. 3) are carried on pallets (designated 28 in FIGS. 4 and 5) from one smart card assembly workstation to the next during the assembly of smart cards on the sheet. The conveyor system 1 includes a continuous track around which the pallets 28 are moved in spaced relation to one another between the workstations. The track is defined by first and second rows of parallel-aligned side rails 3 and cross-transfer rails 4 extending between opposite ends of the rows of side rails 3 to complete a closed circuit around which the pallets can travel during the assembly of smart cards on the sheets that are carried by the pallets.

The pallets 28 are moved along and between the rows of side rails 3 and cross-transfer rails 4 by means of belts 5 which rotate around each rail under the pallets. A plurality of belt motors 7 drive the belts 5 around the rails 3 and 4. In the conveyor system 1 shown in FIG. 1, the pallets ride around the track in a counter-clockwise direction. The combination of the rows of side rails 3, the cross-transfer rails 4 extending therebetween, the belts 5 and the belt drive motors 7 of conveyor system 1 are all commercially available from Bosche-Rexroth of Germany and, therefore, no further description thereof will be provided.

As indicated, the conveyor system 1 includes a series of (e.g., robotically-controlled) smart card assembly workstations between which belt driven pallets 28 are moved during the assembly of smart cards on flat sheets 16 being transported by the pallets. Each workstation of the conveyor system 1 includes one or more stops 9 that are raised to temporarily halt the movement of the pallets until an assembly step has been executed. That is, while the motor-driven belts 5 continue to rotate under the pallets, the ongoing travel of the pallets along the track is impeded at successive workstations by the stops 9 until the assembly step at the workstation has been completed. At this time, the stops 9 are withdrawn so as to enable the pallets 28 to move to the next workstation along the track of the conveyor system 1.

The assembly steps that are common to the production of smart cards are completed at the series of workstations located around the track of the conveyor system 1. By way of particular example, and continuing to refer to FIGS. 1 and 2 of the drawings, the conveyor system 1 includes a single sheet feeding station 60 which represents the beginning of the smart card assembly process. As will be described in greater detail when referring to FIG. 3, individual empty (i.e., pre-assembled) sheets 16 are lifted out of a pull-out drawer (designated 12 in FIG. 3) at the sheet feeding station 60 and placed onto respective pallets (designated 28 in FIGS. 4 and 5) which ride the rails 3 and 4 around the closed circuit track from one workstation to the next.

Following the feeding station 60 and located at the opposite side of the conveyor system 1 via cross-transfer rails 4 are a pair of identical (i.e., redundant) pick-and-place workstations 62 where integrated circuit chips are lifted out of a supply thereof and then installed on the sheet 16 carried by the pallet 28.

After the pick-and-place workstations 62 comes a wire embedding workstation 64 at which antenna wires are embedded in the sheet 16 in close proximity to the integrated circuit chips that were installed at the previous workstations 62.

Located at the opposite side of the conveyor system 1 via the cross-transfer rails 4 are a pair of identical (i.e., redundant) welding workstations 66 at which the antenna wires that were embedded at the previous workstation 64 are now bonded (e.g., welded) to the integrated circuit chips at respective electrical terminals thereof. The reliability of the welds may also be tested to ensure that data can be transmitted to and from the chips. The smart cards formed on the sheet 16 shown in FIG. 3 that is carried on the pallet 28 of FIGS. 4 and 5 around the track of the conveyor system 1 of FIGS. 1 and 2 are now fully assembled. The sheet 16 can now be carried from the conveyor system 1 to a remote cutting station (not shown) where the sheet can be cut apart into individual smart cards.

However, prior to it being carried to the remote cutting station, the completed sheet 16 on which the smart cards are assembled is transported to a single sheet removal station 68 which represents the end of the smart card assembly process and at which the sheet is lifted off its pallet and stacked with other fully assembled sheets in a pull-out drawer 14. The pull-out drawers 12 and 14 of the sheet feeding and sheet removal stations 60 and 68 from which empty sheets are first removed and in which fully assembled sheets are stacked may be identical. The assembled sheets can be manually removed from drawer 14 to be carried to the remote sheet cutting station as just described. The pallet 28 from which the assembled sheet is removed continues to travel on the side rails 3 so as to return from the sheet removal station 68 to the sheet feeding station 60 at which to receive a new empty sheet from the stack of sheets in the drawer 12.

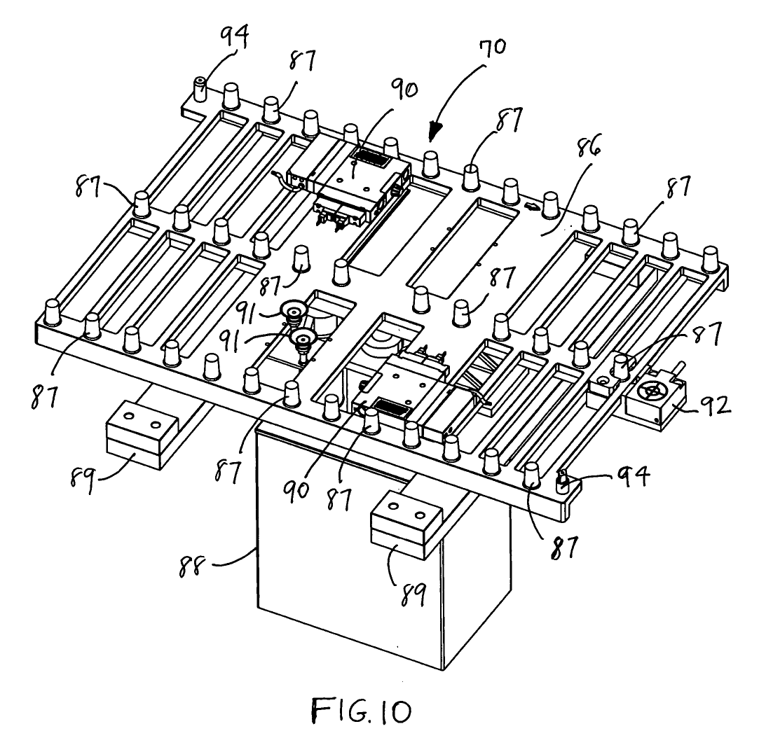

The specific (e.g., robotically-controlled) smart card assembly steps that are executed at the successive pick-and-place, wire embedding, and welding workstations 62, 64 and 66 around the track of conveyor system 1 are known in the smart card production art and are not considered part of the present invention. Nevertheless, each workstation 62, 64 and 66 includes a lift and position platform 70, the details of which will be provided when referring hereinafter to FIG. 10.

As just disclosed, the conveyor system of 1 of FIGS. 1 and 2 includes a pull-out drawer 12 located at a sheet feeding station 60 in which a number of empty, pre-assembled sheets 16 are initially stacked to be removed one at a time to be laid on respective pallets 28 that are moved by motor-driven belts 5 on the rails 3 and 4 of the closed circuit track to successive workstations 62, 64 and 66 until fully assembled sheets are removed from the pallets and stacked within the pull-out drawer 14 of sheet removal station 68.

Referring in this regard to FIG. 3 of the drawings, there is shown in a closed position the pull-out drawer 12 of the sheet feeding station 60 of the conveyor system 1 of FIGS. 1 and 2. The drawer 12 is positioned below the side rails 3 and is loaded with a number of flat, empty sheets 16 that are stacked one above the other. The sheets 16 in drawer 12 are initially devoid of integrated circuit chips and the antenna wires to be added thereto at the series of workstations 62, 64 and 66. Each sheet 16 preferably has a dimension of 400 mm×512 mm and is manufactured from a plastic material, or the like, that may be melted in response to the application of heat by which the antenna wires can be embedded therewithin at the wire embedding workstation 64. The sheets 16 are inscribed with the profiles 18 of a number of individual smart cards to be assembled and then separated from one another when a fully completed sheet 16 is ultimately removed from the drawer 14 of the sheet removal station 68 of FIG. 1 to be carried to the remote cutting station.

In the case of FIG. 3, each sheet 16 in drawer 12 is shown inscribed with an 8×4 array of smart cards. However, the size of sheet 16 and the number of smart cards inscribed thereon should not be considered a limitation of this invention. Each smart card profile 18 on sheet 16 is initially provided with a mounting hole 20 within which an integrated circuit chip (not shown) will be mounted at the pick-and-place workstations 62 of the conveyor system 1 of FIGS. 1 and 2.

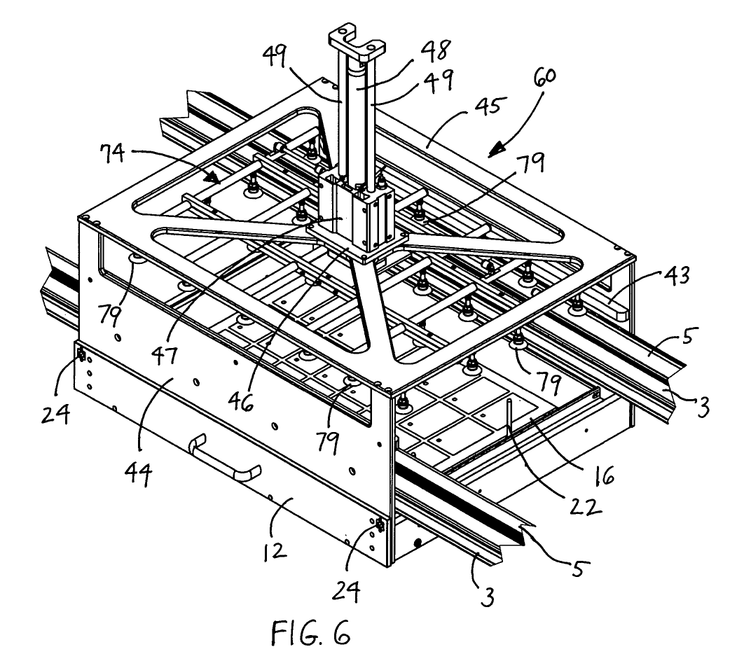

A set of removable sheet locating pins 22 stand upwardly from the interior of the drawer 12 to align the empty sheets 16 in a uniform stack so that a sheet can be lifted out of the drawer to be laid on a pallet 28 (of FIGS. 4 and 5) in a manner that will be described in greater detail when referring to the sheet feeding station 60 of FIGS. 6-9. The locating pins 22 can be removed from drawer 12 when it is desirable to accommodate therewithin sheets of larger size.

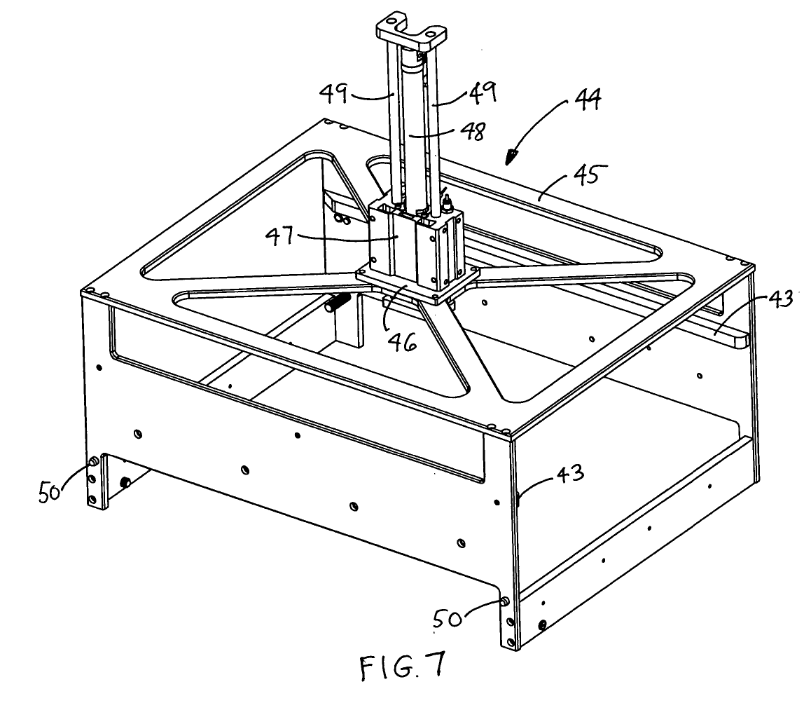

A pair of locating bushings 24 is positioned at opposite ends of the front of drawer 12. The locating bushings 24 are aligned to receive therewithin corresponding nubs (designed 50 in FIG. 7) which project from the front of a frame of the sheet feeding station 60 so that the drawer 12 will be properly closed within the frame to enable individual pre-assembled sheets to be properly positioned to be lifted one at a time outwardly therefrom.

Turning now to FIGS. 4 and 5 of the drawings, a pallet 28 is shown for transporting a flat, empty sheet 16 around the closed circuit track of the conveyor system 1 of FIGS. 1 and 2 from the sheet feeding station 60, past the series of smart card assembly workstations 62, 64 and 66, and to the sheet removal station 68 during the smart card assembly process. The pallet 28 includes a top 30 formed from a hard, electrically non-conductive (e.g., granite) material upon which an empty sheet 16 is initially laid and carried during transit around the conveyor system 1. The (granite) top 30 provides a smooth, hard and non-conductive surface upon which welding the antenna wires to the integrated circuit chips on sheet 16 can be completed and tested at the welding workstations 66 of the conveyor system shown in FIGS. 1 and 2.

Rows of vacuum holes 32 are formed through the top 30 of pallet 28 so as to be aligned for communication with corresponding rows of vacuum channels 34-1 and 34-2 that run as grooves along a vacuum manifold plate 72 (best shown in FIG. 5). A pair of vacuum ports 35 is formed through the vacuum manifold plate 72 so as to communicate with respective vacuum channels 34-1 and 34-2. The vacuum ports 35, the rows of vacuum channels 34-1 and 34-2, and the vacuum holes 32 establish continuous vacuum passages through the pallet 28 at which suction forces are created for holding a flat sheet 16 down against the top 30 of pallet 28 when the smart card assembly steps are executed at the series of workstations of the conveyor system 1. The manner in which the aforementioned suction force is created for holding the sheet down against the top 30 of pallet 28 will be described in greater detail when referring to the lift and position platform 70 shown in FIG. 10.

The vacuum manifold plate 72 is preferably manufactured from aluminum and is secured under the top 30 of pallet 28 so that the vacuum holes 32 through the top 30 and the rows of vacuum channels 34-1 and 34-2 in plate 72 are aligned to communicate with one another. In this same regard, the continuous vacuum passages through the pallet 28 including the vacuum holes 32, the vacuum channels 34-1 and 34-2, and the vacuum ports 35 cooperate with a pair of suction cups of the soon-to-be described lift and position platform 70 of FIG. 10 that is located at each of the workstations 62, 64 and 66 of the conveyor system 1. As will also soon be described, the amount of suction to be applied to the vacuum passages through the pallet 28 depends upon the size of the sheet to be laid upon and held down against the top 30 thereof.

The vacuum manifold plate 72 is secured below the top 30 of pallet 28 by means of a plurality of plastic threaded screws 36 (best shown in FIG. 5) that are inserted through mounting holes 37 in plate 72 for receipt by respective threaded inserts 38 (also best shown in FIG. 5). The inserts 38 are preferably embedded within the top 30 of pallet 28.

To ensure that the vacuum manifold plate 72 is properly positioned against the top 30 of pallet 28 to enable the fasteners 36 to be received by inserts 38 and the vacuum channels 34-1 and 34-2 to be aligned with vacuum holes 32, a pair of alignment pins 39 extend through the vacuum manifold plate 72 for receipt by the top 30 of pallet 28. To ensure that a sheet on which the smart cards are to be assembled is properly laid upon and carried by the pallet 28, a set of sheet locating pins 40 projects upwardly from the top 30 of the pallet 28. The number of sheet locating pins 40 projecting from the top 30 will depend upon the size of the sheet. A pair of diagonally aligned pallet positioning holes 41 are formed through the vacuum manifold plate 72 to receive therewithin pallet locating pins (designated 94 of the soon-to-be-described lift and vacuum platform 70 of FIG. 10).

Located at and extending around the bottom of the pallet 28 is an open-ended, hollow plastic frame 42. The vacuum manifold plate 72 to which the top 30 is affixed is seated upon and connected to the hollow frame 42. Inasmuch as frame 42 is commercially available from Bosche-Rexroth of Germany, no further description thereof will be provided.

An optional RFID (radio frequency identification) tag (not shown) may be carried by the pallet 28 to be read by a reader 92 that is located at the lift and position platform 70 (of FIG. 10). The RFID tag will contain information about the sheet 16 that is transported around the conveyor system 1 of FIGS. 1 and 2 by the pallet 28.

By virtue of the conveyor system 1 and the pallet 28 herein disclosed, a flat plastic sheet 16 on which smart cards are to be assembled is transported continuously and uninterruptedly around the track of the conveyor system 1 of FIGS. 1 and 2 between a series of integrated workstations. Thus, the sheet does not have to be manually handled or carried from one work cell to the next. Moreover, and as will now be disclosed, only a single sheet feeding station 60 and sheet removal station 68 are needed as opposed to multiple stations as has often occurred with separate and independent work cells have been employed. Hence, the smart card assembly process will be more efficient and require less human intervention than that currently associated with conventional smart card production techniques.

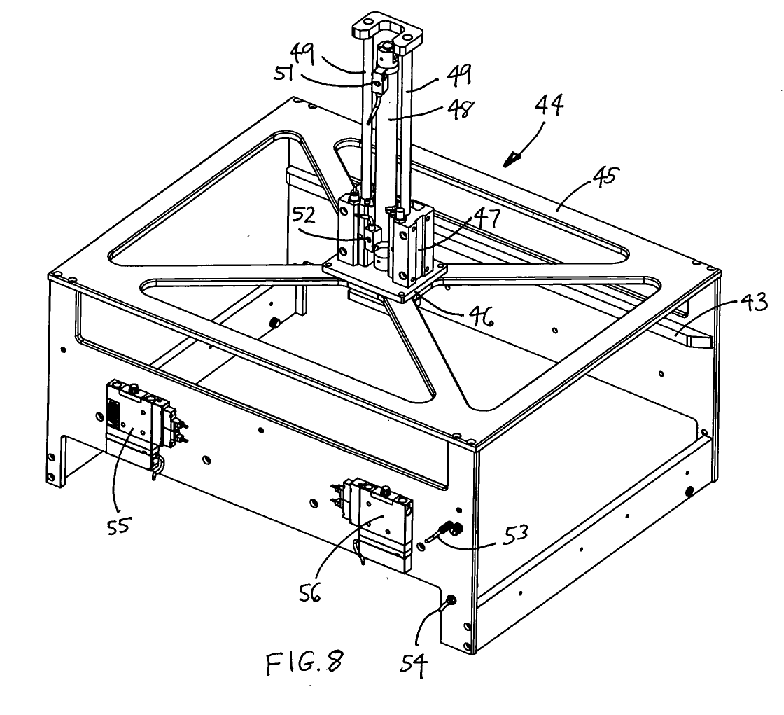

Turning now to FIGS. 6-8 of the drawings, details of the single sheet feeding station (designated 60 in FIGS. 1 and 2) are now disclosed. The sheet feeding station 60 includes a frame 44 (best shown in FIGS. 7 and 8). The sheet feeding station frame 44 extends above the side rails 3 and the drawer 12 within which a fresh supply of empty plastic sheets 16 are stacked and on which the smart cards are to be assembled. A cover 45 is disposed over and across the frame 44 so as to be spaced above the drawer 12 and the pre-assembled sheets 16 that are stacked therewithin.

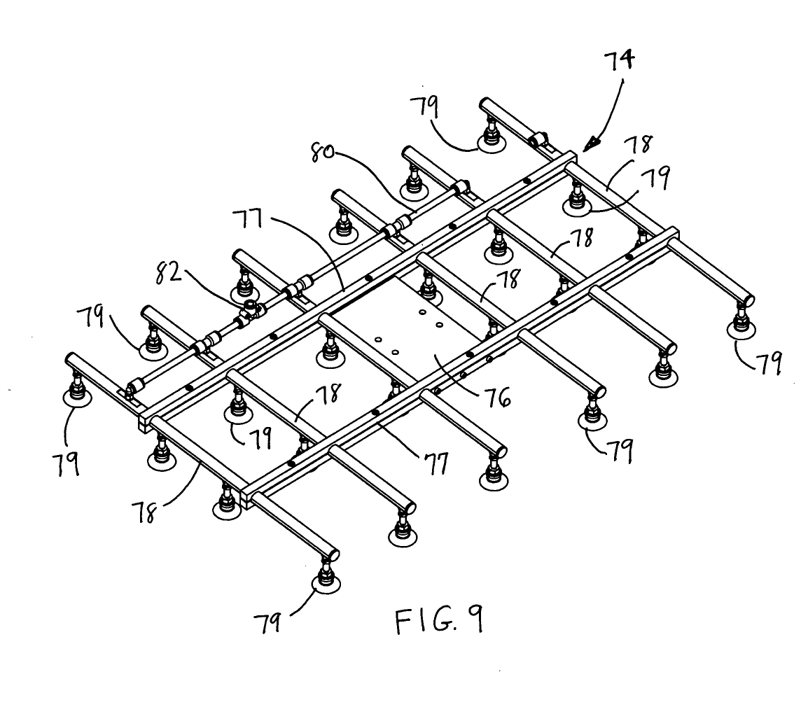

A mounting plate 46 is secured to the top of the cover 45 of the sheet feeding station frame 44. Seated on the mounting plate 46 is a guide body 47. A (e.g., personal computer-controlled) pneumatic cylinder 48 and a pair of guide rods 49 are slidably received by the guide body 46. The pneumatic cylinder 48 and the guide rods 49 are adapted for reciprocal up and down movements relative to the guide body 47 for correspondingly raising and lowering a suction cup array frame 74 (best shown in FIG. 9) through the sheet feeding station frame 44. To accomplish the foregoing, one end of the pneumatic cylinder 48 is attached to the suction cup array frame 74 to impart the reciprocal up and down movements thereto.

As will soon be described, the suction cup array frame 74 includes suction means to be lowered by pneumatic cylinder 48 through the sheet feeding station frame 44 and into contact with the stack of empty sheets 16 within drawer 12. The sheets 16 are then lifted one at a time out of drawer 12 for placement upon respective pallets 28 (of FIGS. 4 and 5) that ride the side rails 3 towards the sheet feeding station 60 so as to be located between a pair of opposing pallet positioning rails 43 under the cover 45 and below the pneumatic cylinder 48. Once a sheet 16 has been lifted out of the drawer 12 and laid upon a pallet 28, the suction cup array frame 74 releases its hold on the sheet 16. The pneumatic cylinder 48 then raises the suction cup array frame 74 through the sheet feeding station frame 44 to be returned to its position as shown in FIG. 6. A combination guide body 47, pneumatic cylinder 48, and guide rods 49 for imparting up and down reciprocal movements to the suction cup array frame 74 through the sheet feeding station frame 44 of sheet feeding station 60 is commercially available from SMC of Japan.

FIG. 7 shows the front of the sheet feeding station frame 44 of sheet feeding station 60 and a pair of nubs 50 at opposite ends thereof. As was previously disclosed when referring to FIG. 3, the nubs 50 are received within respective locating bushings 24 at opposite ends of the front of the drawer 12 in which empty sheets 16 are stacked prior to the assembly of smart cards thereon. In this manner, the drawer 12 and sheet feeding station frame 44 will be aligned with one another so that the stack of sheets 16 will be properly positioned below the pneumatic cylinder 48 whereby individual sheets can be engaged and lifted by the suction cup array frame 74 (of FIG. 9) to be laid upon a pallet 28 which arrives at the sheet feeding station 60.

FIG. 8 shows the rear of the sheet feeding station frame 44 and a pair of sensors 51 and 52 that are associated with the pneumatic cylinder 48 which imparts the up and down reciprocal movements to the suction cup array frame 74 (of FIG. 9). The sensors 51 and 52 monitor the movements of pneumatic cylinder 48 relative to guide body 47 and the number of up and down cycles completed by the pneumatic cylinder when it is desirable to track the number of empty sheets that have been removed from the drawer 12 (of FIG. 3) to be laid upon respective pallets 28. Another pair of sensors 53 and 54 are adapted to verify the presence of a pallet under the suction cup array frame 74 and whether the pull-out drawer 12 is in an open or closed position. That is, it may not be possible to remove an empty sheet 16 from the drawer 12 if the drawer has been opened and pulled outwardly from the sheet feeding station frame 44. Moreover, an empty sheet 16 cannot be removed from the drawer 12 in the closed position if there is already a pallet located below the suction cup array frame 74.

A pair of vacuum generators 55 and 56 are attached at the back of the sheet feeding station frame 44. Such vacuum generators 55 and 56 are also commercially available from SMC of Japan. The vacuum generators 55 and 56 create the vacuum necessary for producing a suction force by which to enable the suction cup array frame 74 to lift the empty sheets 16 out of the drawer 12 and lay the sheets upon respective pallets 28 that move to the sheet feeding station 60 of the conveyor system 1 of FIGS. 1 and 2. A single one or both of the vacuum generators 55 and 56 will be used depending upon the size of the sheets that are stacked within the drawer 12 to be laid upon pallets 28.

The sheet feeding station frame 44 having the suction cup array frame 74 movable therethrough has been shown and described for the sheet feeding station 60 of the conveyor system 1 of FIGS. 1 and 2. However, it is to be understood that the sheet removal station 68 of conveyor system 1 at which fully assembled sheets are lifted off the pallets and lowered into the drawer 14 prior to being cut may include an identical pneumatic cylinder, sheet removing station frame and suction cup array frame as just described when referring to the frames 44 and 74 and pneumatic cylinder 48 of sheet feeding station 60.

FIG. 9 of the drawings shows details of the suction cup array frame 74 at which a suction force is produced and which is moved up and down through the sheet feeding station frame 44 of FIGS. 6-8 for lifting and lowering empty sheets 16 out of the drawer 12 (of FIG. 3) and onto respective pallets 28 (of FIGS. 4 and 5). The suction cup array frame 74 includes a centrally disposed attachment plate 76 to which one end of the pneumatic cylinder 48 (of FIG. 6) is connected so that the reciprocal up and down movements of cylinder 48 will be imparted to frame 74. A pair of support bars 77 retain a plurality of hollow metal tubes 78 in spaced parallel alignment with one another. Each of the hollow tubes 78 communicates with an array of suction cups 79 which are moved into engagement with an empty sheet 16 in drawer 12 to apply a suction force thereagainst so that the sheet can be lifted out of the drawer. A pneumatic tubing 80 is coupled to each of the hollow tubes 78. Pneumatic tubing 80 includes a pneumatic fitting 82 to be coupled to the vacuum generators 55 and 56 at the back of the sheet feeding station frame 44 (of FIG. 8). Accordingly, a vacuum path is established from the vacuum generators 55 and 56 to the array of suction cups 79 via pneumatic tubing 80 and the hollow tubes 78. As previously disclosed, a single one or both of the vacuum generators 55 and 56 is used to generate a vacuum and a corresponding suction force at the array of suction cups 79 depending upon the size of the sheet to be lifted by the suction cup array frame 74.

FIG. 10 of the drawings shows a lift and position platform 70 that is located at each of the pick-and-place, wire embedding, and welding workstations, 62, 64 and 66 around the conveyor system 1 of FIGS. 1 and 2. The purpose of the lift and position platforms 70 is to lift a pallet 28 on which a flat sheet 16 has been laid up and off the track 3 of the conveyor system 1 so as to be moved into cooperative engagement with robots (not shown) which, as earlier indicated, perform the smart card assembly steps at workstations 62, 64 and 66. To this end, the lift and position platform 70 includes a platform base 86 having a plurality of upwardly projecting support fingers 87 upon which a pallet will rest, a pneumatic lifting cylinder (not shown) surrounded by a cover 88 for applying a lifting force to the platform base 86, and a pair of straps 89 lying below the platform base 86 and attached to the side rails 3 of the conveyor system 1. Such a lift and position platform 70 having the aforementioned platform base 86, pneumatic cylinder and cover 88, and straps 89 is commercially available from Bosche-Rexroth of Germany and, therefore, no further description thereof will be provided.

The commercially-available lift and position platform 70 of FIG. 10 is modified to include a pair of vacuum generators 90 which are coupled via vacuum paths (not shown) to respective ones of a pair of suction cups 91. The vacuum generators 90, which are commercially available from SMC of Japan, are adapted to generate a vacuum so that corresponding suction forces will be applied at the suction cups 91. In this regard, with a pallet 28 (of FIGS. 4 and 5) laid upon the support fingers 87 of platform base 86 of lift and position platform 70, the suction cups 91 of platform 70 are received inwardly and through the open-ended hollow frame 42 at the bottom of pallet 28 so as to lie against respective ones of the pair of vacuum ports 35 (best shown in FIG. 4) through the vacuum manifold plate 72 of pallet 28.

Accordingly, a vacuum is generated by each of the vacuum generators 90 of lift and position platform 70 and a suction force is applied from each of the suction cups 91 to the rows of vacuum holes 32 (of FIGS. 4 and 5) that are formed through the top 30 of pallet 28. The suction force is applied between suction cups 91 and vacuum holes 32 via the continuous vacuum passages through the pallet including the pair of vacuum ports 35 which communicate with respective rows of vacuum channels 34-1 and 34-2 of the vacuum manifold plate 72 that is sandwiched between the top 30 and the bottom frame 42 of pallet 28. More particularly, one of the pair of suction cups 91 communicates with one row of vacuum channels 34-1 through one vacuum port 35, and the second suction cup 91 communicates with the other row of vacuum channels 34-2 through the other vacuum port 35. Therefore, the suction force that originates at the suction cups 91 will hold a sheet 16 on which smart cards are to be assembled down against the top 30 of pallet 28 as the pallet is manipulated by the robots at workstations 62, 64 and 66. Like the vacuum generators 55 and 56 of the sheet feeding station frame 44, either a single one or both of the vacuum generators 90 at the lift and position platform 70 of FIG. 10 will be used depending upon the size of the sheet to be held against the pallet 28 and the magnitude of the suction force required.

As earlier disclosed, the lift and position platform 70 carries an RFID reader 92 which is positioned when the pallet 28 is laid upon the platform base 86 to read an RFID tag that is attached to the pallet. As also earlier disclosed, the lift and position platform 70 includes a pair of diagonally disposed, pallet locating pins 94 to be received through respective pallet positioning holes 41 (best shown in FIG. 5) formed in the vacuum manifold plate 72 of pallet 28 whereby to prevent the pallet 28 from being displaced relative to the base 86 of the lift and position platform 70 during manipulation of the platform by the robots during the smart card assembly manufacturing steps.

By virtue of the foregoing, a sheet will be reliably held against the top 30 of the pallet 28, and the pallet 28 will be reliably held against the lift and position platform 70 to facilitate an efficient and accurate assembly of smart cards on the sheet that is laid upon and transported by the pallet 28 around the closed circuit track of the conveyor system 1 of FIGS. 1 and 2.

I claim:

1. A conveyor system for the manufacture of smart cards including a track and a series of smart card assembly workstations located along the track, said conveyor system comprising:
a plurality of empty sheets on which smart cards are to be assembled;
a plurality of pallets to be positioned on the track in spaced relation to one another;
means by which to move said plurality of pallets along the track from one of the series of smart card assembly workstations to the next; and
a sheet feeder to automatically place successive ones of said plurality of empty sheets on respective ones of said plurality of pallets so that said empty sheets are transported by said pallets along the track to the series of smart card assembly workstations.

2. The conveyor system recited in claim 1, wherein said sheet feeder includes a suction cup frame and at least one suction cup at which a suction force is created, said at least one suction cup being carried by said suction cup frame into contact with said plurality of empty sheets for placing under said suction force successive ones of said sheets onto respective ones of said plurality of pallets.

3. The conveyor system recited in claim 2, wherein said sheet feeder also includes a pull-out drawer spaced below said suction cup frame and the at least one suction cup carried thereby, said plurality of empty sheets being stacked one above the other within said pull-out drawer to be placed onto respective ones of said plurality of pallets.

4. The conveyor system recited in claim 2, wherein said sheet feeder also includes a vacuum generator and said suction cup frame includes pneumatic tubing extending between said vacuum generator and said at least one suction cup, said vacuum generator producing a vacuum for creating said suction force at said suction cup by way of said pneumatic tubing for causing successive ones of said plurality of empty sheets to be placed onto respective ones of said plurality of pallets.

5. The conveyor system recited in claim 2, wherein said sheet feeder also includes a pneumatic cylinder connected to said suction cup frame and adapted for movement in opposite directions relative to said plurality of empty sheets for moving said suction cup frame and the at least one suction cup carried thereby into contact with said plurality of empty sheets for moving under said suction force successive ones of said sheets onto respective ones of said plurality of pallets.

6. The conveyor system recited in claim 5, wherein said sheet feeder also includes a sheet feeder frame for supporting said pneumatic cylinder in spaced alignment above said plurality of empty sheets so that said suction cup frame and the at least one suction cup carried thereby move downwardly relative to said sheet feeder frame and into contact with said plurality of empty sheets and then upwardly for placing by means of said suction force successive ones of said sheets onto respective ones of said plurality of pallets.

7. The conveyor system recited in claim 1, further comprising a sheet remover to remove each of said plurality of sheets on which smart cards have been assembled from respective ones of said plurality of pallets that have moved along the track and past the series of smart card assembly workstations, said sheet remover including a suction cup frame and at least one suction cup at which a suction force is created, said at least one suction cup being carried by said suction cup frame into contact with successive ones of said plurality of smart card assembled sheets for removing under said suction force said sheets from said pallets.

8. The conveyor system recited in claim 7, wherein said sheet remover also includes a pull-out drawer spaced below said suction cup frame and the at least one suction cup carried thereby, said plurality of smart card assembled sheets being stacked one above the other within said pull-out drawer after successive ones of said sheets have been removed from respective ones of said plurality of pallets.

9. The conveyor system recited in claim 7, wherein said sheet remover also includes a vacuum generator and said suction cup frame includes pneumatic tubing extending between said vacuum generator and said at least one suction cup, said vacuum generator producing a vacuum for creating said suction force at said suction cup by way of said pneumatic tubing for causing successive ones of said plurality of smart card assembled sheets to be removed from respective ones of said plurality of pallets.

10. The conveyor system recited in claim 7, wherein said sheet remover also includes a pneumatic cylinder connected to said suction cup frame and adapted for movement in opposite directions relative to said plurality of smart card assembled sheets for moving said suction cup frame and the at least one suction cup carried thereby into contact with said plurality of smart card assembled sheets for removing successive ones of said sheets from respective ones of said plurality of pallets.

11. The conveyor system recited in claim 10, wherein said sheet remover also includes a sheet remover frame for supporting said pneumatic cylinder in spaced alignment above said plurality of smart card assembled sheets so that said suction cup frame and the at least one suction cup carried thereby move downwardly relative to said sheet remover frame and into contact with said plurality of smart card assembled sheets and then upwardly for removing by means of said suction force successive ones of said sheets from respective ones of said plurality of pallets.

12. The conveyor system recited in claim 1, wherein said means by which to move said plurality of pallets along the track includes a motor-driven belt for pushing said pallets from one of the series of smart card assembly workstations to the next.

13. The conveyor system recited in claim 1, wherein the track has a continuous, closed circuit configuration.

14. The conveyor system recited in claim 1, wherein each of said plurality of pallets on which successive ones of said plurality of empty sheets are placed has a vacuum passage extending therethrough at which a suction force is applied for holding said sheets against said pallets.

15. The conveyor system recited in claim 14, wherein each of said plurality of pallets includes a top on which one of said plurality of empty sheets is placed and a vacuum manifold plate connected to said top, said vacuum passage extending through each of said top and said vacuum manifold plate so that said suction force is applied to the said one sheet on said top.

16. The conveyor system recited in claim 15, wherein said vacuum passage includes a plurality of vacuum holes formed through the top of each of said plurality of pallets and a plurality of vacuum channels running along said vacuum manifold plate thereof and communicating with said vacuum holes.

17. The conveyor system recited in claim 16, wherein the top of each of said plurality of pallets is manufactured from an electrically non-conductive material.

18. The conveyor system recited in claim 14, further comprising a lift and position platform located at at least one of the series of smart card assembly workstations so as to engage successive ones of said plurality of pallets moving along the track and lift said pallets off the track by which to enable the assembly of smart cards on said plurality of sheets being transported by said pallets, said lift and position platform having at least one suction cup to communicate with the vacuum passage of each of said plurality of pallets, whereby said suction force is applied from the suction cup of said lift and position platform through the vacuum passage of said pallet for holding said plurality of sheets against respective ones of said plurality of pallets.

19. The conveyor system recited in claim 18, wherein said lift and position platform also has a vacuum generator communicating with said at least one suction cup thereof and providing a vacuum for creating said suction force to be applied from said suction cup through the vacuum passage of successive ones of said plurality of pallets for holding said plurality of sheets against respective ones of said pallets.

20. A conveyor system for the manufacture of smart cards including a track and a series of smart card assembly workstations located along the track, said conveyor system comprising:
a plurality of empty sheets on which smart cards are to be assembled;
a plurality of pallets to be positioned on the track in spaced relation to one another;
means by which to move said plurality of pallets along the track from one of the series of smart card assembly workstations to the next;
a sheet feeder to automatically place successive ones of said plurality of empty sheets on respective ones of said plurality of pallets so that said empty sheets are transported by said pallets along the track to the series of smart card assembly workstations; and
a sheet remover to remove each of said plurality of sheets on which smart cards have been assembled from respective ones of said plurality of pallets that have moved along the track and past the series of smart card assembly workstations.

21. A conveyor system for the manufacture of smart cards including a track and a series of smart card assembly workstations located along the track, said conveyor system comprising:
a plurality of empty sheets on which smart cards are to be assembled;
a plurality of pallets to be positioned on the track in spaced relation to one another;
means by which to move said plurality of pallets along the track from one of the series of smart card assembly workstations to the next; and
a sheet feeder to automatically place successive ones of said plurality of empty sheets on respective ones of said plurality of pallets so that said empty sheets are transported by said pallets along the track to the series of smart card assembly workstations,
each of said plurality of pallets having a vacuum passage extending therethrough at which a suction force is applied for holding said plurality of empty sheets on respective ones of said plurality of pallets.

22. For a conveyor system for the manufacture of smart cards including a track and at least one smart card assembly workstation located along the track, a pallet to transport an empty sheet on which a smart card will be assembled, said pallet to be positioned on the track to carry the empty sheet to the smart card assembly workstation therealong, and said pallet having a vacuum passage extending therethrough at which a suction force is applied for holding the empty sheet against the pallet.
